(19) United States
(12) Patent Application Publication
(10) Pub. No.: US 2024/0388684 A1
(43) Pub. Date: Nov. 21, 2024

(54) VIRTUAL OBJECT DISPLAY METHOD AND APPARATUS, DEVICE, AND STORAGE MEDIUM

(71) Applicant: Tencent Technology (Shenzhen) Company Limited, Shenzhen (CN)

(72) Inventor: Teng CHEN, Shenzhen (CN)

(73) Assignee: Tencent Technology (Shenzhen) Company Limited, Shenzhen (CN)

(21) Appl. No.: 18/785,286

(22) Filed: Jul. 26, 2024

Related U.S. Application Data
(63) Continuation of application No. PCT/CN2023/118092, filed on Sep. 11, 2023.

(30) Foreign Application Priority Data
Oct. 13, 2022 (CN) 202211255861.5

(51) Int. Cl. H04N 13/156; G06T 19/00; H04N 13/00; H04N 13/167; H04N 13/178; H04N 13/398

(52) U.S. Cl. CPC H04N 13/156; G06T 19/006; H04N 13/167; H04N 13/178; H04N 13/398; H04N 2013/0081; H04N 2013/0085

(57) ABSTRACT

A virtual object display method, performed by a terminal device, includes: displaying a first area of a virtual social scene and at least one virtual object located in the first area of a user interface; and based on a first virtual object in the virtual social scene having social information to be displayed, and based on the first virtual object being located outside a second area of the virtual social scene including an entirety or a part of the first area, displaying the first virtual object in the user interface and displaying the social information.

### CROSS-REFERENCE TO RELATED APPLICATIONS

This application is a continuation application of International Application No. PCT/CN2023/118092 filed on Sep. 11, 2023, which claims priority to Chinese Patent Application No. 202211255861.5, filed on Oct. 13, 2022, the disclosures of each being incorporated by reference herein in their entireties.

### FIELD

The disclosure relates to the field of computer and internet technologies, and in particular, to a virtual object display method and apparatus, a device, and a storage medium.

### BACKGROUND

With the development of internet technologies, virtual socialization has gradually become a popular social manner. In a virtual social scene, a virtual object has corresponding social information. For example, after the first virtual object sends a message to a master virtual object of a user, the social information may be displayed above the head of the first virtual object.

Limited by the size of a user interface, a picture of a virtual social scene corresponding to an area range centered on the master virtual object may be displayed in the user interface. When the first virtual object is relatively far away from the master virtual object, the first virtual object and the social information of the first virtual object may not be completely displayed in the user interface.

### SUMMARY

Provided are a virtual object display method and apparatus, a device, and a storage medium.

According to some embodiments, a virtual object display method, performed by a terminal device, includes: displaying a first area of a virtual social scene and at least one virtual object located in the first area of a user interface; and based on a first virtual object in the virtual social scene having social information to be displayed, and based on the first virtual object being located outside a second area of the virtual social scene including an entirety or a part of the first area, displaying the first virtual object in the user interface and displaying the social information.

According to some embodiments, a virtual object display apparatus, includes: at least one memory configured to store computer program code; and at least one processor configured to read the program code and operate as instructed by the program code, the program code including: area display code configured to cause at least one of the at least one processor to display a first area of a virtual social scene and at least one virtual object located in the first area of a user interface; and object display code configured to cause at least one of the at least one processor to: based on a first virtual object in the virtual social scene having social information to be displayed, and based on the first virtual object being located outside a second area of the virtual social scene including an entirety or a part of the first area, display the first virtual object in the user interface and display the social information.

According to some embodiments, a non-transitory computer-readable storage medium, storing computer code which, when executed by at least one processor, causes the at least one processor to at least: display a first area of a virtual social scene and at least one virtual object located in the first area of a user interface; and based on a first virtual object in the virtual social scene having social information to be displayed, and based on the first virtual object being located outside a second area of the virtual social scene including an entirety or a part of the first area, display the first virtual object in the user interface and display the social information.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment according to some embodiments.

FIG. 2 is a schematic diagram of a solution application scenario according to some embodiments.

FIG. 3 is a flowchart of a virtual object display method according to some embodiments.

FIG. 4 is a schematic diagram of a virtual social scene of a virtual object according to some embodiments.

FIG. 5 is a schematic diagram of a user interface of a virtual object according to some embodiments.

FIG. 6 is a schematic diagram of sizes of an interaction range of a virtual object and a user interface according to some embodiments.

FIG. 7 is a schematic diagram of coordinates of a user interface of a virtual object according to some embodiments.

FIG. 8 is a flowchart of a virtual object display method according to some embodiments.

FIG. 9 is a schematic diagram of a virtual object control display manner according to some embodiments.

FIG. 10 is a flowchart of a virtual object display method according to some embodiments.

FIG. 11 is a schematic diagram of a posture of a virtual object according to some embodiments.

FIG. 12 is a flowchart of a virtual object display method according to some embodiments.

FIG. 13 is a schematic diagram of a user interface according to some embodiments.

FIG. 14 is a block diagram of a virtual object display method according to some embodiments.

FIG. 15 is a block diagram of a virtual object display method according to some embodiments.

FIG. 16 is a block diagram of a virtual object display apparatus according to some embodiments.

FIG. 17 is a block diagram of a virtual object display apparatus according to some embodiments.

FIG. 18 is a structural block diagram of a terminal device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

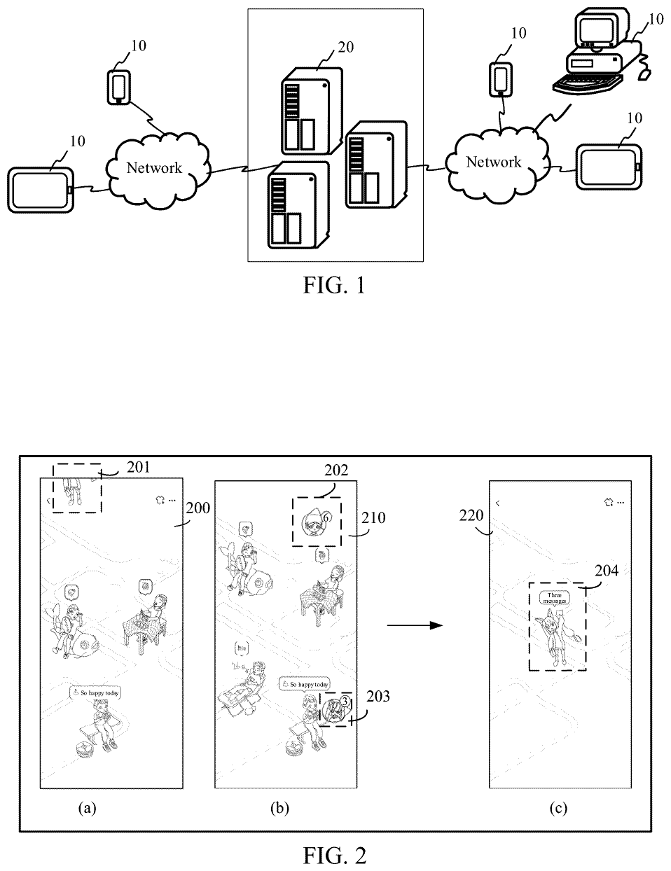

FIG. 1 is a schematic diagram of an implementation environment according to some embodiments. The implementation environment may include: a terminal device 10 and a server 20.

The terminal device 10 includes but is not limited to electronic devices such as a mobile phone, a tablet computer, an intelligent speech interaction device, a game console, a wearable device, a multimedia playback device, a personal computer (PC), an in-vehicle terminal, and an intelligent appliance. A client of a target application (for example, a game application) may be installed on the terminal device 10. In some embodiments, the target application may be an application that is downloaded and installed or may be a click-to-use application. This is not limited.

In some embodiments, the target application may be any one of a social application, a simulation program, an escape shooting game, a virtual reality (VR) application, an augmented reality (AR) program, a three-dimensional map program, a virtual reality game, an augmented reality game, a first-person shooting (FPS) game, a multiplayer shooting survival game, a third-person shooting (TPS) game, a multiplayer online battle arena (MOBA) game, a simulation game (SLG), or an interaction entertainment application. In addition, layout manners of virtual social scenes supported by different applications are different. This is not limited. In some embodiments, a client of the application runs on the terminal device 10.

The virtual social scene is a scene displayed (or provided) when the client of the target application (for example, the game application) runs on the terminal device. The virtual social scene refers to a scene created for a virtual object to perform activities (for example, game competition), for example, a virtual house, a virtual island, or a virtual map. The virtual social scene may be a simulated environment of a real world, may be a semi-simulated and semi-fictional environment, or may be a completely fictional environment. The virtual social scene may be a two-dimensional virtual environment, a 2.5-dimensional virtual environment, or a three-dimensional virtual environment. This is not limited.

The virtual object is a virtual character, a virtual vehicle, a virtual item, or the like controlled by a user account in the target application. This is not limited. For example, the target application is a social application, and the virtual object is a game character controlled by a user account in the social application. The virtual object may be in a human shape, an animal shape, a cartoon shape, or another shape. This is not limited. The virtual object may be presented in a three-dimensional form or a two-dimensional form. This is not limited. In some embodiments, when the virtual social scene is the three-dimensional virtual environment, the virtual object is a three-dimensional model created based on a skeletal animation technology. Each virtual object has a shape and a volume in the three-dimensional virtual environment, and occupies some space in the three-dimensional virtual environment. Activities of the virtual object include but are not limited to: at least one of adjusting body postures, crawling, walking, running, riding, jumping, driving, picking, shooting, attacking, or throwing. For example, the virtual object is a virtual person such as a simulated person role or a cartoon person role.

The server 20 is configured to provide a backend service for the client of the target application in the terminal device 10. For example, the server 20 may be an independent physical server, may be a server cluster or a distributed system formed by a plurality of physical servers, or may be a cloud server that provides a cloud computing service such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

In some embodiments, the terminal device 10 includes a first terminal device 11 and a second terminal device 12. A first client of the target application is installed on the first terminal device, and a second client of the target application is installed on the second terminal device. A first user account of a first user controls a first virtual object in the first client of the target application, and a second user account of a second user controls a master virtual object in the second client of the target application. In some embodiments, the first virtual object and the master virtual object are located in the virtual social scene. In some embodiments, the first virtual object and the master virtual object may have a friend relationship, belong to a same camp, a same team, or a same organization, or have a temporary communication permission. In some embodiments, the first virtual object and the master virtual object may not have a friend relationship, or belong to different camps, different teams, or different organizations. In some embodiments, the client installed on the first terminal device is the same as the client installed on the second terminal device, or the clients installed on the two terminal devices are clients of a same type on different operating system platforms (Android system or iOS system). The first terminal device may refer to one of a plurality of terminal devices, and the second terminal device may refer to another one of the plurality of terminal devices. In some embodiments, the first terminal device and the second terminal device are used as an example for description.

The terminal device 10 may communicate with the server 20 through a network. The network may be a wired network or may be a wireless network.

FIG. 2 is a schematic diagram of a solution application scenario of a virtual object display method according to some embodiments.

As shown in a sub-figure a in FIG. 2, a first virtual object and social information 201 of the first virtual object cannot be completely displayed in a user interface 200. It may be found according to the sub-figure a that parts of the first virtual object and the social information 201 of the first virtual object are displayed in the user interface 200. As shown in a sub-figure b in FIG. 2, the first virtual object and the social information of the first virtual object are not displayed in a user interface 210, but are displayed in the user interface 210 in a manner of an indication icon 202 and an indication icon 203. The indication icon may display a profile picture of a user sending information and point to a direction of the first virtual object. The user moves a screen in the direction and can find the corresponding first virtual object.

For a case in which the first virtual object is relatively far away from the master virtual object, the first virtual object and the social information of the first virtual object are displayed in a manner of the sub-figure a or are displayed in a manner of the sub-figure b. However, the first virtual object and the social information of the first virtual object cannot be completely displayed in the two manners. In a virtual social scene, after a virtual object sends a message, a message bubble may be displayed above a head of the virtual object, and a user may tap the bubble to read the unread message. Because a size of a screen is limited, a case in which a part of a virtual object is just exposed from the screen definitely occurs, and information about the virtual object is not displayed completely. If a message bubble is not displayed, the user does not know that the virtual object sends a message. For example, as shown in the sub-figure a in FIG. 2, the user does not know that the virtual object on a top left corner sends a message. Although a direction of a virtual object may be indicated, the user may attempt to find a location, which may be far away. After unread content increases, a large quantity of user profile pictures densely exists on an entire edge of the screen, which may interfere with normal use. When the screen is moved, a front end may calculate a direction in real time, resulting in relatively large performance consumption. The solutions provided in the related art may not be conducive for the user to timely obtain a message, and human-computer interaction may be relatively poor.

In some embodiments, the first virtual object may be displayed in the user interface, and the social information is displayed. As shown in a sub-figure c in FIG. 2, a first virtual object and social information 204 of the first virtual object are displayed in a user interface 220. It can be learned that the first virtual object and the social information 204 of the first virtual object are completely displayed in the user interface 220. According to some embodiments, the first virtual object is completely displayed in the user interface, so that the user can see the whole virtual object at a glance, which facilitates the user to obtain the social information in time and improves a social experience sense of the user.

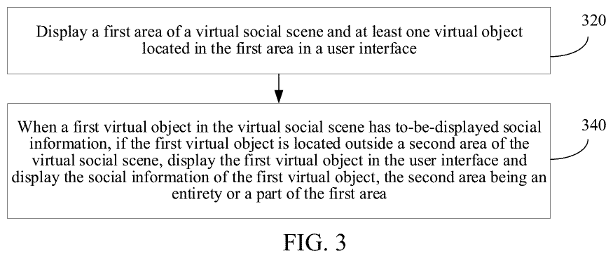

FIG. 3 is a flowchart of a virtual object display method according to some embodiments. An execution entity of operations of the method may be the terminal device 10 in the implementation environment shown in FIG. 1, for example, the execution entity of the operations may be the client of the target application. In the following method according to some embodiments, for ease of description, the “client” is used as an example of the execution entity of the operations for description. The method may include at least one of the following operations (320 and 340).

Operation 320: Display a first area of a virtual social scene and at least one virtual object located in the first area in a user interface.

The virtual social scene is a scene displayed (or provided) when an application runs on a terminal. The virtual social scene may be a simulated world of a real world, may be a semi-simulated and semi-fictional three-dimensional world, or may be a completely fictional three-dimensional world. The virtual social scene may be any one of a two-dimensional virtual environment, a 2.5-dimensional virtual environment, or a three-dimensional virtual environment. In some embodiments, the virtual social scene is further configured for a virtual environment battle between at least two virtual objects, and there are virtual resources available to the at least two virtual objects in the virtual social scene.

A virtual object is a movable object or an immovable object in the virtual social scene. The movable object may be at least one of a virtual person, a virtual animal, or a cartoon person. The immovable object may be at least one of a virtual building, a virtual plant, or a virtual terrain. In some embodiments, when the virtual social scene is the three-dimensional virtual environment, the virtual object may be a three-dimensional virtual model. Each virtual object has a shape and a volume in the three-dimensional virtual environment, and occupies some space in the three-dimensional virtual environment. In some embodiments, the virtual object is a three-dimensional character constructed based on a three-dimensional human skeleton technology. The virtual object wears different skins to implement different appearances. In some implementations, the virtual object may be implemented by using a 2.5-dimensional model or a two-dimensional model. This is not limited. For example, the virtual object may be classified into a virtual object controlled by a user and a virtual object controlled by a server according to different manners of controlling the virtual object. The virtual object controlled by the user is a movable object controlled by a client in the virtual social scene. The virtual object controlled by the server is a virtual object controlled by an automatic control algorithm or an artificial intelligence program on the client or the server. The virtual object controlled by the server includes the movable object and the immovable object in the virtual social scene. For example, the immovable object may respond to or affect an activity of the movable object. For example, the movable object may destroy the immovable object, or when the movable object enters the immovable object, the movable object enters an invisible state. For example, a master virtual object is a virtual object controlled by the client. For example, a first virtual object may be a virtual object controlled by another client or server.

In some embodiments, the user interface may be considered as a display surface of a terminal device corresponding to the master virtual object. A size, brightness, and the like of the user interface are not limited. In some embodiments, an area in the virtual social scene displayed in the user interface is considered as the first area.

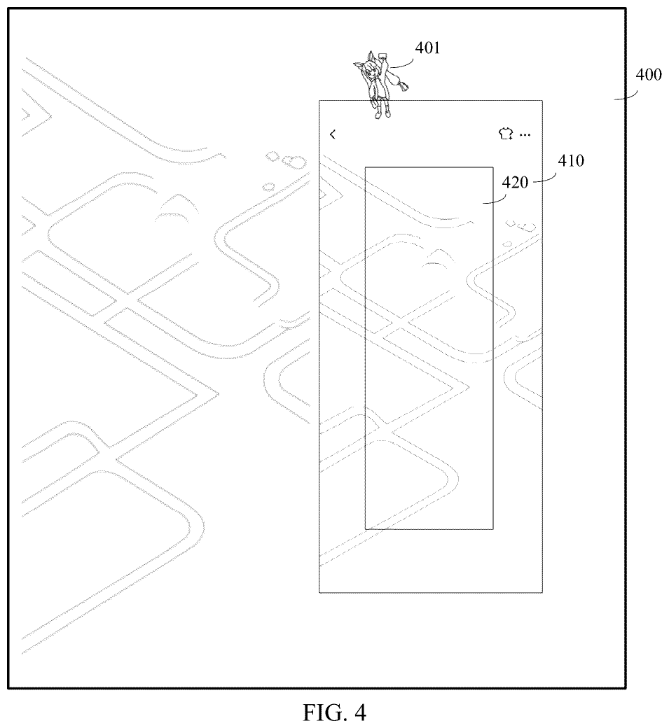

In some embodiments, as shown in FIG. 4, a first virtual object 401 exists in a virtual social scene 400, and a first area of the virtual social scene 400 is displayed in a user interface 410. At least one virtual object in the first area of the virtual social scene 400 is displayed. In some embodiments, the user interface 410 displays the first area that is determined from the virtual social scene 400 and that uses a master virtual character as a center. In some embodiments, the user interface may display another area of the virtual social scene 400 according to a first operation performed by a user. A type of the first operation is not limited. In some embodiments, the first operation is a sliding operation. When the user slides on a screen, the user interface 410 displays the another area of the virtual social scene 400, and a master virtual object is not displayed at a center location of the user interface 410.

Operation 340: When a first virtual object in the virtual social scene has to-be-displayed social information, if the first virtual object is located outside a second area of the virtual social scene, control the first virtual object to be displayed in the user interface and display the social information of the first virtual object. The second area is an entirety or a part of the first area.

Social information: information related to a virtual object in a social application scene may be considered as the social information. In some embodiments, the social information is at least one of a quantity or content of messages sent by the first virtual object to the master virtual object. In some embodiments, the social information is at least one of a personal signature, an instant, or a live released by the first virtual object. A type and content of the social information are not limited. The to-be-displayed social information may be considered as social information that has not been viewed or reviewed by a current user.

The second area is an entirety or a part of the first area. Similar to the first area, the second area is also a part of the virtual social scene. As shown in FIG. 4, a second area 420 is a part of the first area, and the second area is inside the first area.

In some embodiments, when the first virtual object in the virtual social scene does not have the to-be-displayed social information, the first virtual object is not displayed in the user interface. When the first virtual object does not have the to-be-displayed social information, an example in which the social information is a quantity of unread messages is used, if the master virtual object does not receive a message sent by the first virtual object, the current user may not intend to view the first virtual object. Therefore, to reduce processing overheads, when the first virtual object in the virtual social scene does not have the to-be-displayed social information, the first virtual object is not displayed in the user interface.

In some embodiments, if the first virtual object is located inside the second area of the virtual social scene, the first virtual object is not displayed in the user interface. Considering that the second area is the entirety or the part of the first area, and the user interface displays the first area. Therefore, when the first virtual object is located inside the second area of the virtual social scene, the first virtual object has been displayed in the user interface.

In some embodiments, when the first virtual object in the virtual social scene has the to-be-displayed social information, if the first virtual object is located outside the second area of the virtual social scene, the first virtual object may be displayed in the user interface and the social information of the first virtual object may be displayed. In some embodiments, the first virtual object may be displayed in the user interface when the first virtual object in the virtual social scene has the to-be-displayed social information and the first virtual object is located outside the second area of the virtual social scene. The first virtual object may be displayed in the user interface when the first virtual object has the to-be-displayed social information. According to some embodiments, the first virtual object and the social information are displayed. Therefore, processing overheads of a device may be reduced, and accuracy and efficiency of controlling display of the virtual object may be improved.

In some embodiments, there are a plurality of manners of controlling the first virtual object to be displayed in the user interface. In some embodiments, the first virtual object is directly transmitted to a target location in the first area, and the user can directly view that the first virtual object appears at the target location. The target location is a final location of the first virtual object. According some embodiments, the first virtual object may be displayed in the first area in a direct transmission manner. After the target location is determined, the virtual object may be directly displayed at the target location, which helps reduce costs of controlling movement of the virtual object, reduce processing overheads of a device, and improve display efficiency of the first virtual object.

In some embodiments, the first virtual object is controlled to move to the target location in the first area, for example, the first virtual object is controlled to move to the target location by using a posture such as running or walking, and the user may observe the movement of the first virtual object. According to some embodiments, the first virtual object is displayed in the user interface in a manner of controlling the first virtual object to move to the first area, which may give a user a relatively real social experience sense.

In some embodiments, similar to a manner in which the user slides on the screen, a display area of the user interface is adjusted, so that the user interface displays an area in which the first virtual object is located. This display is also in a slow moving manner, and display of the area is continuous. According to some embodiments, the display area of the user interface is directly adjusted, and the area in which the first virtual object is located is displayed in the user interface in the slow moving manner, which also gives the user the relatively real social experience sense, as if the user discovers the first virtual object with the movement of the user interface. When the first virtual object is a fixed object, for example, when the first virtual object is a house, this manner is relatively close to reality, and may enhance a user experience.

In some embodiments, the display area of the user interface is directly adjusted, and the user interface is controlled to directly display from the first area to the area in which the first virtual object is located. According to some embodiments, the display area of the user interface is directly adjusted according to the area in which the first virtual object is located, so that the processing overheads of the device can also be reduced, and the display efficiency of the first virtual object is improved.

In some embodiments, if the first virtual object is located outside the second area of the virtual social scene and the first virtual object is located in a fourth area of the virtual social scene, the operation of controlling the first virtual object to be displayed in the user interface and displaying the social information of the first virtual object is performed. The first area is a part of the fourth area. In some embodiments, if the first virtual object is located outside the fourth area of the virtual social scene, the first virtual object is not displayed in the user interface. Because the first area is the part of the fourth area, the fourth area is an area larger than the first area. Therefore, the fourth area is defined, so that when the first virtual object is relatively far away from a location of the first area in which the master virtual object is located, the first virtual object is not displayed in the user interface. According to some embodiments, when the first virtual object is relatively far away from the master virtual object, the first virtual object is not displayed in the user interface, so that a problem of the processing overheads of the device is considered, and a quantity of virtual objects displayed in the user interface is also controlled. If an area in which the virtual object may be displayed is not limited, the first virtual objects may be displayed in the user interface, which may cause an excessively quantity of virtual objects in the user interface, resulting in reduction of the user experience sense. When the first virtual object is located in the fourth area and is not located in the second area, the first virtual object may be displayed in the user interface, so that a quantity of virtual objects displayed in the user interface can be controlled. In addition, excessive processing costs of the device are not wasted, and interference with normal use of the user is avoided.

The fourth area: similar to the first area, the fourth area is also an entirety or a part of the virtual social scene. In some embodiments, a range of the fourth area is larger than a range of the second area, and an annular area may be formed between the fourth area and the second area.

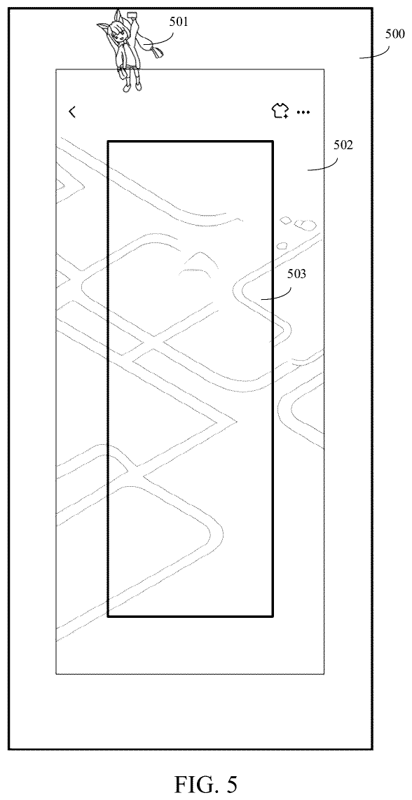

As shown in FIG. 5, if a first virtual object 501 is located outside a second area 503 of a virtual social scene and the first virtual object 501 is located in a fourth area 500 of the virtual social scene, the first virtual object 501 may be displayed in a user interface 502.

In some embodiments, when there are a plurality of first virtual objects that are to be displayed, priorities of the plurality of first virtual objects are scored, and a sequence of the plurality of first virtual objects that are to be displayed is determined according to scores of the priorities. In some embodiments, the score of the priority is related to at least one of a frequency of interaction between the first virtual object and the master virtual object, an intimate relationship between the first virtual object and the master virtual object, acquaintance duration between the first virtual object and the master virtual object, a quantity of unread messages, or the like. In some embodiments, the factors affecting the score of the priority have different weights. The score of the priority may be determined based on a score determining model such as a neural network model. In some embodiments, the plurality of first virtual objects may be displayed in the user interface one by one, for example, after one first virtual object may be displayed in the user interface, a next first virtual object may be displayed in the user interface. According to some embodiments, a sequence of the displayed first virtual objects is controlled according to the scores of the priorities, so that the display of the first virtual object may increase coincidence with a user's expectations.

In some embodiments, the second area is a part of the first area, and a size of an annular area located outside a bounding box of the second area and inside a bounding box of the fourth area is related to a size of an interaction range of the first virtual object. The first virtual object and the social information of the first virtual object are displayed in the interaction range of the first virtual object.

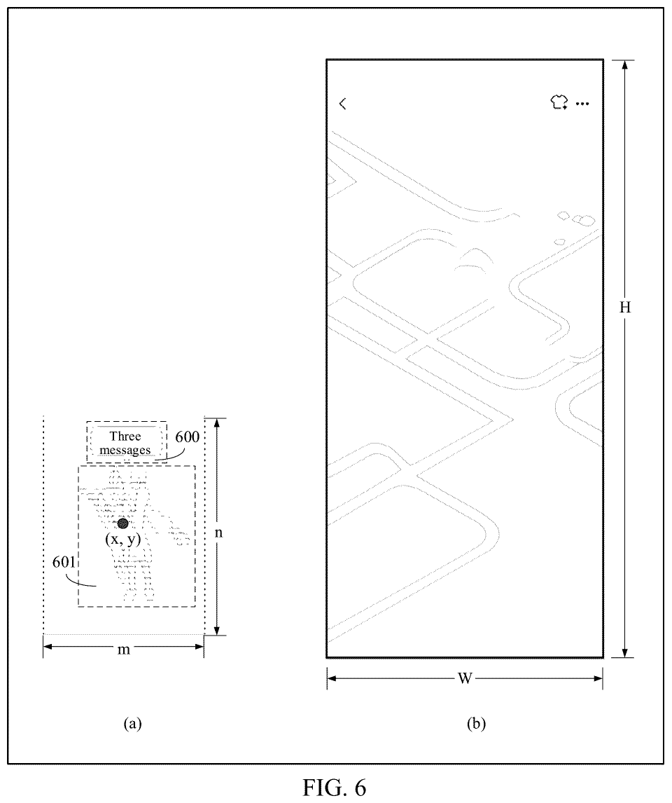

In some embodiments, the interaction range is a range that can include the first virtual object and the social information of the first virtual object. In some embodiments, the interaction range is a matrix interaction box. There are the first virtual object and the social information of the first virtual object in the matrix interaction box. As shown in FIG. 6, a sub-figure a shows an interaction range of a first virtual object. A length of the interaction range is m, and a width of the interaction range is n, where m and n are positive numbers. The interaction range includes a first virtual object 601 and social information 600 of the first virtual object 601.

In some embodiments, a size of the first area corresponds to a size of the user interface. As shown in a sub-figure b in FIG. 6, a length of the first area is W, and a width of the first area is H, where W and H are positive numbers.

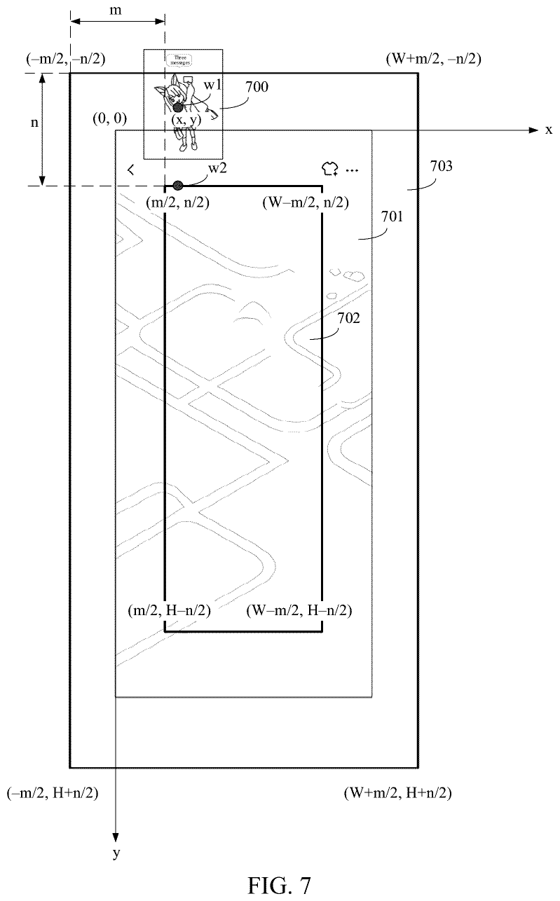

In some embodiments, as shown in FIG. 7, a two-dimensional coordinate system is established by using a vertex at a top left corner of a first area 701 as an origin (0, 0), a horizontal direction to the right as an x axis, and a vertical direction to the down as a y axis. In addition, a center of an interaction range 700 of a first virtual object is considered as a location of the first virtual object in the virtual social scene. A size of an annular area formed between a second area 702 and a fourth area 703 is related to the interaction range 700 of the first virtual object. It can be learned from FIG. 6 that a length of the interaction range 700 is m, a width of the interaction range 700 is n, a length of the first area is W, and a width of the first area is H. It can be learned according to the established two-dimensional coordinate system that coordinates of four vertexes of the second area are (m/2, n/2), (W−m/2, n/2), (m/2, H−n/2), and (W−m/2, H−n/2). Coordinates of four vertexes of the fourth area are (−m/2, −n/2), (W+m/2, −n/2), (−m/2, H+n/2), and (W+m/2, H+n/2).

In some embodiments, a central location of the interaction range 700 is (x, y). When the central location falls in the fourth area 703 and outside the second area 702, the first virtual object may be displayed in the user interface.

In some embodiments, an area to which the first virtual object belongs is determined according to a location of the first virtual object or a location of the interaction range of the first virtual object. The location of the first virtual object may be a location of a center point of the first virtual object, or may be a location of a place of the first virtual object (for example, a location of a foot). The location of the interaction range of the first virtual object may be a location of a center point of the interaction range or another location. The center point may be a center of gravity or a centroid. This is not limited.

In some embodiments, in the foregoing manner, the first virtual object and the social information of the first virtual object that are not displayed in an original display range of the second area can be displayed in the original display range of the second area. The first virtual object and the social information of the first virtual object are displayed in a display range in which the second area is located and that is in the user interface.

In some embodiments, the method further includes operation 330.

Operation 330: Determine an area range of at least one of the second area or the fourth area.

In some embodiments, the area range of the second area and/or the area range of the fourth area may be preset or may be readjusted according to setting of the user. In some embodiments, after a user selects different virtual social scenes and different sizes of first virtual objects or adjusts a size of the master virtual object, the corresponding area range of the second area and/or the corresponding area range of the fourth area also changes. A size of a virtual object is a size of a model of the virtual object or a size of an interaction range in which the virtual object is located.

In some embodiments, a border line of the second area and/or a border line of the fourth area may be displayed in the user interface based on an area adjustment operation performed by the user. The displayed border line is editable. The user may set the area range of the second area and/or the area range of the fourth area in a manner of dragging the border line. The area adjustment operation may be an operation such as touching and holding or tapping performed by the user on a control or may be an operation of sliding on a screen. An operation type is not limited, and any operation that can be performed by the user to adjust an area falls within the disclosure.

In some embodiments, operation 330 includes operation 330-1 to operation 330-3.

Operation 330-1: Determine, based on a size relationship between the first area and a master virtual object, a target interaction distance of the master virtual object.

In some embodiments, the first area is a W*H matrix area, and a size of an interaction range in which the master virtual object is located is set to L*Z. In some embodiments, A right triangle using (W−L)/2 and (H−Z)/2 as cathetuses is determined, and a length of a hypotenuse of the right triangle is used as the target interaction distance of the master virtual object. L and Z are positive numbers, W is greater than L, and H is greater than Z.

Operation 330-2: Determine a circular area using the target interaction distance as a radius and a location of the master virtual object as a center as the area range of the second area.

Operation 330-3: Determine the area range of the fourth area based on the first area and the target interaction distance, a distance between a point in the fourth area and a bounding box of the first area being less than the target interaction distance.

In some embodiments, the first area is a W*H matrix area, and a size of an interaction range in which the master virtual object is located is set to L*Z. In some embodiments, a rectangular range using the master virtual object as a center and (W−L)/2 and (H−Z)/2 as a length and a width is determined as the second area. The fourth area is a rectangular range using the master virtual object as a center and W+L/2 and H+Z/2 as a length and a width.

In some embodiments, the first area is a W*H matrix area, and a size of the interaction range in which the first virtual object is located is m*n. In some embodiments, a rectangular range using the master virtual object as a center and W-m and H-n as a length and a width is determined as the second area. The fourth area is a rectangular range using the master virtual object as a center and W+m and H+n as a length and a width.

In some embodiments, the virtual social scene is a three-dimensional scene. A corresponding area displayed in the user interface is converted into the three-dimensional scene in a coordinate system conversion manner. There is a corresponding first area in the three-dimensional scene, and points of the first area in the three-dimensional scene may be completely mapped to the user interface. The second area and the fourth area are similar to the first area.

According to some embodiments, a manner of determining the area range of the second area and/or the area range of the fourth area is not limited, and the second area and the fourth area may be determined according to the size of the first virtual object or the size of the interaction range in which the first virtual object is located, or the second area and the fourth area may be determined according to the size of the master virtual object or the size of the interaction range in which the master virtual object is located. In addition, in addition to using a location of the master virtual object or a location of the interaction range of the master virtual object as a center, the second area and the fourth area may further use a center of an area of the virtual social scene currently displayed in the user interface as a center. After the sizes of the second area and the fourth area are determined, a center is not limited. Therefore, according to some embodiments, the determining of the second area and the fourth area is combined with the interaction range of the first virtual object, so that the determined second area and fourth area relatively fit to the actual first virtual object. In addition, in consideration of controlling processing costs, the costs of controlling the display of the first virtual object are minimized, but the efficiency is maximized. The interaction distance may be determined with reference to the size of the master virtual object and the size of the first area, and the second area and/or the fourth area may be further determined according to the target interaction distance, so that the determined second area and/or fourth area more fits to the user interface, and when the user watches, the determined second area and/or fourth area is also a relatively comfortable display manner for the user.

Some embodiments provide a plurality of manners of determining the area range of the second area and/or the area range of the fourth area, so that area determining manners are enriched, and the area may be manually adjusted by the user. Therefore, human-computer interaction is improved, and application policies of a social application scene are also enriched.

According to some embodiments, a first area of a virtual social scene is displayed in a user interface. When a first virtual object has to-be-displayed social information and the first virtual object is located outside a second area of the virtual social scene, the first virtual object and the social information of the first virtual object are displayed in the user interface. The first virtual object that is located outside the second area and that has the to-be-displayed social information is displayed in the user interface. When the first virtual object is relatively far away from the master virtual object, the first virtual object and the social information of the first virtual object can be completely displayed in the user interface, so that a user can directly see the first virtual object and view the to-be-displayed social information of the first virtual object, which facilitates the user to view the social information, and can further view a complete image of the first virtual object. Therefore, the first virtual object and the social information are displayed relatively completely, thereby improving interest of a social application and improving human-computer interactivity.

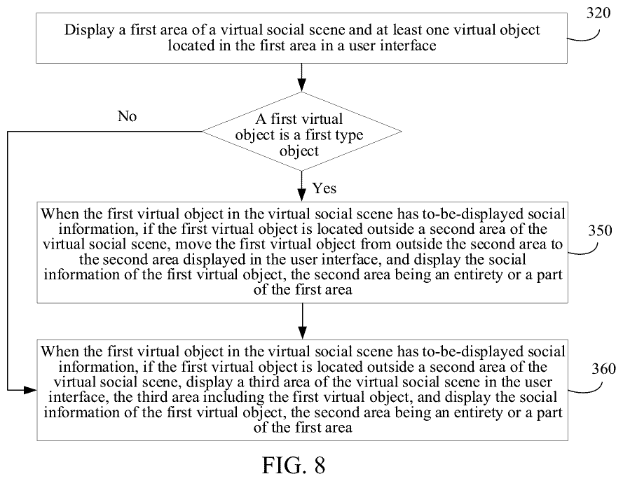

FIG. 8 is a flowchart of a virtual object display method according to some embodiments. An execution entity of operations of the method may be the terminal device 10 in the implementation environment shown in FIG. 1, for example, the execution entity of the operations may be the client of the target application. In the following method according to some embodiments, for ease of description, the “client” is used as an example of the execution entity of the operations for description. The method may include at least one of the following operations (320 to 360).

Operation 320: Display a first area of a virtual social scene and at least one virtual object located in the first area in a user interface.

Operation 322: Determine whether a first virtual object is a first type object.

If the first virtual object is the first type object, operation 350 is performed. If the first virtual object is not the first type object, operation 360 is performed.

The first type object is a movable object and includes but is not limited to a virtual person, a virtual vehicle, a virtual toy, a virtual item, and the like. A second type object corresponds to the first type object. The second type object is an immovable object and includes but is not limited to a task non-player character (NPC) appearing at a fixed location, an immovable virtual building, an immovable virtual view, and the like. The first type object and second type object are not limited.

In some embodiments, considering adaptability of the user, different division is performed according to different types of virtual objects. For the movable first type object, the first virtual object is moved to a second area, so that the first virtual object is displayed in a user interface. Because the first virtual object is a movable object, the first virtual object is controlled to move, for example, the virtual object may be controlled to enter the second area in a walking or running manner. This relatively fits an image of the virtual object, and helps improve a social scene experience sense of the user. For the immovable second type object, the user interface displays a third area in which the first virtual object is located, so that the user can clearly and intuitively view the first virtual object.

The first type object is not limited. The first type object may be an object within a threshold range from a master virtual object, and the second type object is an object outside the threshold range from the master virtual object. When the first virtual object is relatively close to the master virtual object, the first virtual object may be controlled to move to the second area. When the first virtual object is relatively far away from the master virtual object, the user interface is controlled to directly display the third area in which the first virtual object is located.

Operation 350: When the first virtual object in the virtual social scene has to-be-displayed social information, if the first virtual object is located outside a second area of the virtual social scene, control the first virtual object to move from outside the second area to the second area displayed in the user interface, and display the social information of the first virtual object, the second area being an entirety or a part of the first area.

When the first virtual object is the first type object, operation 350 is performed.

The second area includes a border line of the second area and an area within the border line of the second area. In some embodiments, the first virtual object is controlled to move from outside the second area to the border line of the second area or to the area within the border line of the second area.

A manner of controlling the first virtual object to move from outside the second area to the second area is not limited. A target location of the first virtual object may be determined in the second area, and the first virtual object is directly displayed at the target location. The first virtual object may be controlled in a moving manner to walk or run to the target location. For details, reference may be made to the foregoing descriptions.

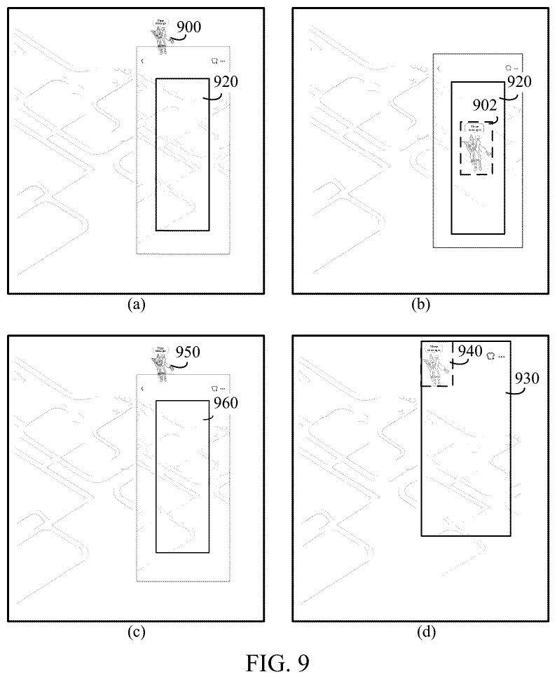

As shown in a sub-figure a in FIG. 9, a first virtual object 900 in a virtual social scene has to-be-displayed social information. If the first virtual object 900 is located outside a second area 920 of the virtual social scene, the first virtual object is controlled to move from outside the second area 920 to the second area 920 displayed in a user interface. As shown in a sub-figure b in FIG. 9, the first virtual object and social information 902 of the first virtual object are displayed in the user interface. The first virtual object 900 may be considered as the first type object.

Operation 360: When the first virtual object in the virtual social scene has to-be-displayed social information, if the first virtual object is located outside a second area of the virtual social scene, display a third area of the virtual social scene in the user interface, the third area including the first virtual object, and display the social information of the first virtual object, the second area being an entirety or a part of the first area.

When the first virtual object is not the first type object, in some embodiments, when the first virtual object is the second type object, operation 360 is performed.

As shown in a sub-figure c in FIG. 9, a first virtual object 950 in a virtual social scene has to-be-displayed social information. If the first virtual object 950 is located outside a second area 960 of the virtual social scene, as shown in a sub-figure d, a third area 930 of the virtual social scene is displayed in a user interface, and the first virtual object and social information 940 of the first virtual object are also displayed in the user interface. The first virtual object 950 may be considered as the second type object.

The third area is an area different from the first area in the virtual social scene, and the first virtual object exists in the third area. In some embodiments, the third area is an area using the first virtual object as a center and a target size as an area range. The target size is not limited.

According to some embodiments, when the first virtual object is the first type object, the first virtual object is controlled to move to the second area, so that the first virtual object can be completely displayed in the user interface in a manner of moving the virtual object. When the first virtual object is not the first type object, the third area of the virtual social scene is displayed in the user interface, so that the user conveniently views the social information of the first virtual object and can intuitively view an image of the first virtual object. The object types of the first virtual object are classified. Different control display manners are used for virtual objects of different types, which may fit features of different virtual objects and meet images of different virtual objects, so that the display efficiency of the virtual object is further improved.

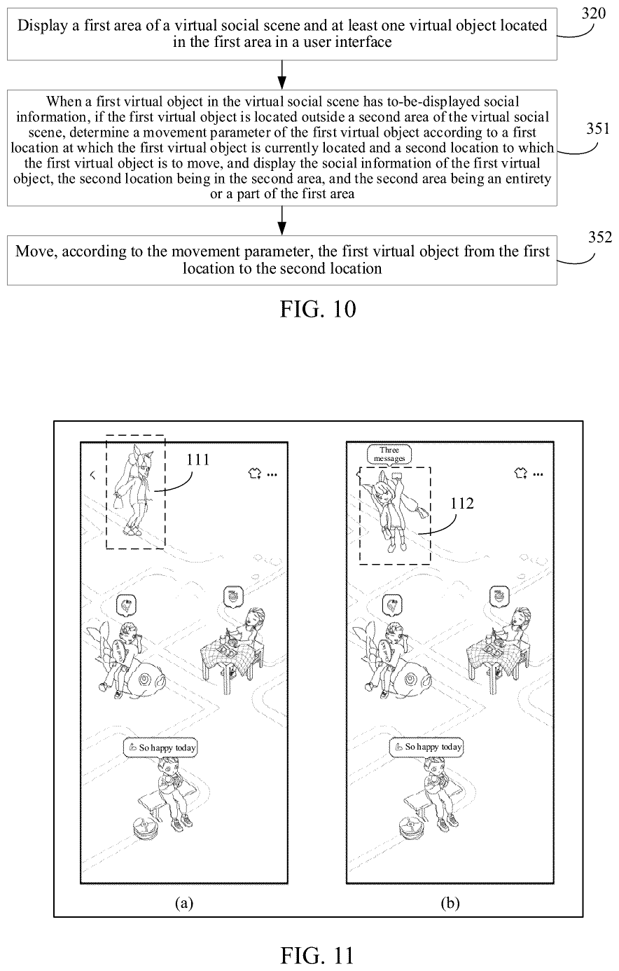

FIG. 10 is a flowchart of a virtual object display method according to some embodiments. An execution entity of operations of the method may be the terminal device 10 in the implementation environment shown in FIG. 1, for example, the execution entity of the operations may be the client of the target application. In the following method according to some embodiments, for ease of description, the “client” is used as an example of the execution entity of the operations for description. The method may include at least one of the following operations (320 to 352).

Operation 320: Display a first area of a virtual social scene and at least one virtual object located in the first area in a user interface.

Operation 351: When a first virtual object in the virtual social scene has to-be-displayed social information, if the first virtual object is located outside a second area of the virtual social scene, determine a movement parameter of the first virtual object according to a first location at which the first virtual object is currently located and a second location to which the first virtual object is to move, and display the social information of the first virtual object, the second location being in the second area, and the second area being an entirety or a part of the first area.

In some embodiments, the second location is any location in the second area. In some embodiments, the second location is any location within a first threshold range around a master virtual object. In some embodiments, an area within the first threshold range around the master virtual object is smaller than the second area.

The movement parameter includes but is not limited to a moving direction, a moving path, a moving speed, and the like of a virtual object.

In some embodiments, a distance that the virtual object is to move is determined according to the second location and the first location. In some embodiments, the second location and the first location each have coordinates. Distances that the first virtual object is to respectively move in a horizontal direction and a vertical direction can be learned according to the first location and the second location. In some embodiments, the coordinates of the first location are (1, 1), and the coordinates of the second location are (3, 5), indicating that the first virtual object is to move by a distance of two units in the horizontal direction and move by a distance of four units in the vertical direction. In some embodiments, the first virtual object is directly controlled to move in a straight direction from the first location to the second location according to the principle that the shortest path between two points is a straight line. In some embodiments, when an obstacle exists between the first location and the second location, the first virtual object cannot directly move in the straight direction from the first location to the second location, and the moving path is adaptively adjusted according to a location of the obstacle. In some embodiments, when there is a rule for the movement of the first virtual object, for example, when the first virtual object can move in the horizontal direction or the vertical direction, the first virtual object may move to the second location by a distance of two units in the horizontal direction and may move to the second location by a distance of four units in the vertical direction.

In some embodiments, the moving speed of the first virtual object may be preset, or may be controlled by the user. The moving speed of the first virtual object is adjusted based on a speed adjustment operation performed by the user. The speed adjustment operation may be an operation such as touching and holding or tapping performed by the user on a control or may be an operation of sliding on a screen. An operation type is not limited, and any operation that can be performed by the user to adjust a speed of the virtual object falls within scope of the disclosure.

In some embodiments, time for which the first virtual object starts to move to moves to the second location may be preset. The moving speed of the first virtual object is determined according to the time and the determined moving path.

In some embodiments, before operation 351, the method further includes operation 351-1.

In some embodiments, the second location is on a border line of the second area.

Operation 351-1: Determine a location point closest to the first location on a bounding box of the second area as the second location.

In some embodiments, a location of a center point of the first virtual object is considered as the first location of the first virtual object.

As shown in FIG. 7, a location point wl of the center point of the first virtual object is considered as the first location of the first virtual object. The point w1 of the first location of the first virtual object may be outside the second area 702, and a point w2 may be determined on a border line of the second area 702, where the point w2 is a point closest to the point w1 in the second area 702. As shown in FIG. 7, a connection line between the point w1 and the point w2 is perpendicular to the x axis.

According to some embodiments, the location point closest to the first location on the bounding box of the second area is determined as the second location, a direction and a location offset of the first virtual object are obtained according to the first location and the second location, and the offset parameter of the first area is determined according to the second location and the first location, so that the first virtual object and the social information of the first virtual object can be completely displayed at minimum moving costs. Therefore, the processing overheads of the device can be reduced, and the display efficiency of the virtual object can be accelerated.

Operation 352: Move, according to the movement parameter, the first virtual object from the first location to the second location.

In some embodiments, the movement parameter is displacement of the first virtual object in the horizontal direction and the vertical direction.

In some embodiments, a location of the first virtual object is set to (x, y), and displacement that the first virtual object is to move on the x axis is X′. When the location of the center point (the first location) of the first virtual object is −m/2<x<m/2, X′=m/2−x. When the location of the center point (the first location) of the first virtual object is m/2≤x≤W−m/2, X′=0. When the location of the center point (the first location) of the first virtual object is W−m/2<x<W+m/2, X′=W−m/2−x. The displacement X′ may be a negative number, indicating that the first virtual object moves in a direction opposite to the x axis.

In some embodiments, displacement that the first virtual object is to move on the y axis is set to Y′. When the location of the center point (the first location) of the first virtual object is −n/2<y<n/2, Y′=n/2−x. When the location of the center point (the first location) of the first virtual object is n/2≤x<H−n/2, Y′=0. When the location of the center point (the first location) of the first virtual object is H−n/2<x<H+n/2, Y′=H−n/2−Y.

In some embodiments, a vector a is recorded as (X′, Y′), and the vector a represents a displacement vector of the first virtual object.

In some embodiments, the first virtual object is controlled to move by the vector a within a timeframe.

In some embodiments, after operation 352, the method further includes operation 353.

In some embodiments, the first virtual object is displayed in a first form when moving, the first virtual object is displayed in a second form when not moving, and the first form is different from the second form.

In some embodiments, the first form is a movable form, and the second form is a stationary form. In some embodiments, the movable form includes a running form, a slow walking form, a fast walking form, a driving form, and the like. The stationary form includes a standing form, a sitting form, a lying form, and the like. Form types of the first form and the second form are not limited.

As shown in a sub-figure a in FIG. 11, a first form 111 of a first virtual object is a movable form, for example, the first virtual object is displayed in a user interface by using a movable appearance. As shown in a sub-figure b in FIG. 11, a second form 112 of the first virtual object is a stationary form.

According to some embodiments, the first virtual object is classified into the first form and the second form, so that the user may distinguish whether the first virtual object is in a movement process or a non-movement process. In addition, the first virtual object is displayed in a realistic form, thereby increasing interest in a social scene.

Operation 353: When the first virtual object meets a first condition, control the first virtual object to move from the second location back to the first location.

In some embodiments, when the first virtual object meets the first condition, the first virtual object is controlled to move back to the first location. In some embodiments, without changing a location of the first virtual object stored in the server, a location of the first virtual object displayed in the terminal device may change. For example, different virtual objects displayed in user interfaces of different users may have different locations, but a location of each virtual object in the server may not change. In some embodiments, a location of each virtual object in the server may be synchronized. This is not limited. When the first virtual object meets the first condition, the first virtual object is controlled to move back to the first location, so that the user interface can be cleared without increasing a quantity of virtual objects in the user interface, which affects use and viewing of the user. Similarly, the first virtual object is controlled to move back to the first location, which can enrich social manners and improve social interest.

In some embodiments, the first condition includes at least one of the following: duration for which the first virtual object is completely displayed in the user interface is greater than or equal to a threshold; the social information of the first virtual object has been viewed; or a related task of the first virtual object has been completed.

In some embodiments, when duration for which the first virtual object is controlled to move and be displayed in the user interface is greater than or equal to a threshold, the first virtual object is controlled to move back to the first location. For example, the threshold is five minutes. Once display time reaches five minutes, the first virtual object is immediately controlled to move back to the first location. This is to avoid waste of resources when the user is busy with another thing and does not view the user interface. Controlling the first virtual object to move back to the first location is helpful to reduce the processing overheads of the device.

In some embodiments, when the social information of the first virtual object has been viewed by the user, the first virtual object is controlled to move back to the first location. When the social information is an unread message sent by the first virtual object to the user, if the user views the social information, it is considered that the social information of the first virtual object has been viewed, and the first virtual object is controlled to move back to the first location. According to some embodiments, when the social information is viewed by the user, the first virtual object is controlled to move back to the first location, so that movement time of the virtual object can be reduced, waste of resources is reduced, and the user interface of the user is cleared more quickly to prepare for display of a next first virtual object.

In some embodiments, when a task corresponding to the first virtual object has been completed by the user, the first virtual object is controlled to move back to the first location. For example, the task of the first virtual object is “acquiring 100 life values”. When the task is completed, the first virtual object is controlled to move back to the first location. Similarly, reducing the processing overheads and clearing the user interface are considered, and the social experience sense of the user is further improved.

In some embodiments, the first location and the second location are determined, and the first virtual object is controlled to move according to the movement parameter, so that movement of the virtual object can be more purposeful. Therefore, how to move the first virtual object can be determined more quickly, thereby improving a display speed of the virtual object.

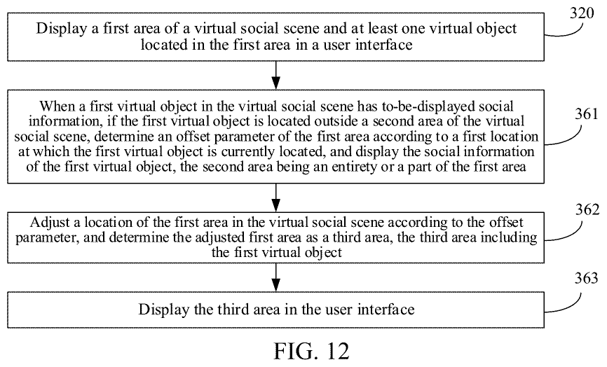

FIG. 12 is a flowchart of a virtual object display method according to some embodiments. An execution entity of operations of the method may be the terminal device 10 in the implementation environment shown in FIG. 1, for example, the execution entity of the operations may be the client of the target application. In the following method according to some embodiments, for ease of description, the “client” is used as an example of the execution entity of the operations for description. The method may include at least one of the following operations (320 to 363).

Operation 320: Display a first area of a virtual social scene and at least one virtual object located in the first area in a user interface.

Operation 361: When a first virtual object in the virtual social scene has to-be-displayed social information, if the first virtual object is located outside a second area of the virtual social scene, determine an offset parameter of the first area according to a first location at which the first virtual object is currently located, and display the social information of the first virtual object, the second area being an entirety or a part of the first area.

In some embodiments, operation 361 includes at least one of the following several operations (operation 361-1 and operation 361-2).

Operation 361-1: Determine a location point closest to the first location on a bounding box of the second area as a third location.

Operation 361-2: Determine the offset parameter of the first area according to the first location at which the first virtual object is currently located and the third location of the second area.

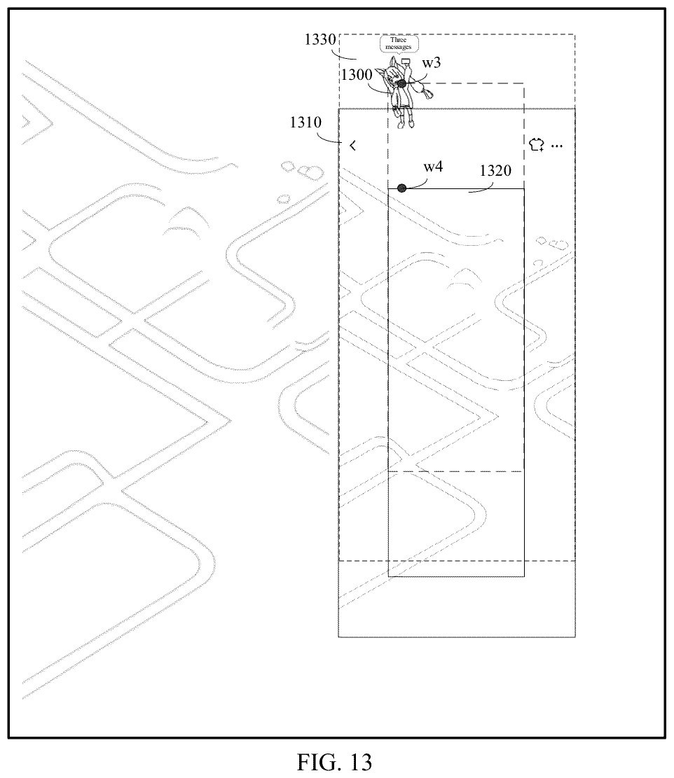

In some embodiments, as shown in FIG. 13, in a virtual social scene, a location point w3 of a center point of a first virtual object 1300 is a first location, and a point w4 in a second area 1320 is a location point closest to the point w3 in the second area. Therefore, the point w4 is a third location. An offset parameter is determined according to the first location and the third location. As shown in the figure, a connection line between the point w3 and the point w4 is perpendicular to the horizontal direction. Therefore, the offset parameter shown in FIG. 13 is an offset in the vertical direction. In some embodiments, a distance between the point w3 and the point w4 is 5, and the offset parameter of the first area is determined as 5. A first area 1310 is moved by five units in the vertical direction, to obtain a changed first area, for example, a third area 1330.

In some embodiments, the offset parameter of the first area is an offset parameter of a screen. However, corresponding to a virtual social scene, there is a scaling difference between an offset value of the first area and an offset value of the screen.

Operation 362: Adjust a location of the first area in the virtual social scene according to the offset parameter, and determine the adjusted first area as a third area, the third area including the first virtual object.

Operation 363: Display the third area in the user interface.

In some embodiments, after operation 363, the method further includes operation 364.

Operation 364: When the first virtual object meets a first condition, switch an area displayed in the user interface from the third area back to the first area.

In some embodiments, the first condition includes at least one of the following: duration for which the first virtual object is completely displayed in the user interface is greater than or equal to a threshold; the social information of the first virtual object has been viewed; or a related task of the first virtual object has been completed.

According to some embodiments, the first virtual object is directly displayed in a manner of displaying the third area in the user interface, thereby enriching social manners and improving social interest.

According to some embodiments, the location point closest to the first location on the bounding box of the second area is determined as the third location, a direction and a location offset of the first virtual object are obtained according to the first location and the third location, and the offset parameter of the first area is determined according to the third location and the first location, so that the first virtual object and the social information of the first virtual object can be completely displayed at minimum moving costs. Therefore, the processing overheads of the device can be reduced, and the display efficiency of the virtual object can be accelerated.

In some embodiments, when duration for which the first virtual object is controlled to move and be displayed in the user interface is greater than or equal to a threshold, the area displayed in the user interface is switched from the third area back to the first area. For example, the threshold is five minutes. Once display time reaches five minutes, the area displayed in the user interface is immediately switched from the third area back to the first area. This is to avoid waste of resources when the user is busy with another thing and does not view the user interface. Switching the area displayed in the user interface from the third area back to the first area is helpful to reduce the processing overheads of the device.

In some embodiments, when the social information of the first virtual object has been viewed by the user, the area displayed in the user interface is switched from the third area back to the first area. When the social information is an unread message sent by the first virtual object to the user, if the user views the social information, it is considered that the social information of the first virtual object has been viewed, and the area displayed in the user interface is switched from the third area back to the first area. According to some embodiments, when the social information is viewed by the user, the area displayed in the user interface is switched from the third area back to the first area, so that time for switching the areas can be reduced, and waste of resources is reduced, to prepare for display of a next first virtual object.

In some embodiments, when a task corresponding to the first virtual object has been completed by the user, the area displayed in the user interface is switched from the third area back to the first area. For example, the task of the first virtual object is “acquiring 100 life values”. When the task is completed or when the user obtains the task, the area displayed in the user interface is switched from the third area back to the first area. Similarly, reducing the processing overheads and clearing the user interface are considered, and the social experience sense of the user is further improved.

In some embodiments, the first location and the third location are determined, and the location of the third area is determined according to the offset parameter, so that display of the user interface can be more purposeful. Therefore, the area to be displayed in the user interface can be determined more quickly, thereby improving a display speed of the virtual object.

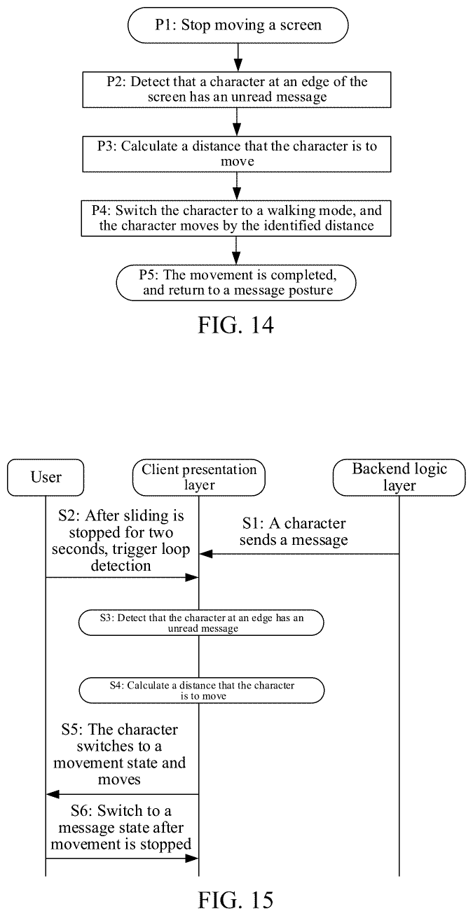

FIG. 14 is a block diagram of a virtual object display method according to some embodiments. An execution entity of operations of the method may be the terminal device 10 in the implementation environment shown in FIG. 1, for example, the execution entity of the operations may be the client of the target application. In the following method according to some embodiments, for ease of description, the “client” is used as an example of the execution entity of the operations for description. The method may include at least one of the following several operations (P1 to P5).

Operation P1: Stop moving a screen.

After a user stops sliding on the screen for two seconds, unread message detection is enabled.

Operation P2: Detect that a character at an edge of the screen has an unread message.

When it is detected that there is a character having an unread message at the edge, and a center point of the character falls within an area, it is determined that a location of the character is to be moved.

Operation P3: Calculate a distance that the character is to move.

Operation P4: Switch the character to a walking mode, and the character moves by the indicated distance.

After the distance that the character is to move and a direction in which the character is to move are calculated, the character moves in a walking posture by the indicated distance.

Operation P5: The movement is completed, and return to a message posture.

After the movement is completed, the character returns to a standing posture of the unread message.

FIG. 15 is a block diagram of a virtual object display method according to some embodiments. The method may include at least one of the following several operations (S1 to S6).

Operation S1: A client presentation layer receives a message sent by a character of a backend logic layer.

Operation S2: After a user stops sliding for two seconds, trigger loop detection.

Operation S3: The client presentation layer detects that the character at an edge has an unread message.

Operation S4: The client presentation layer calculates a distance that the character is to move.

Operation S5: The character switches to a movement state and moves.

The movement state and the foregoing walking mode are similar and are the states of the character when the character moves.

Operation S6: Switch to a message state after movement is stopped.

The message state and the message posture are similar and are states of the character when the character stops.

The following describes an apparatus according to some embodiments, which can be used to execute the method according to some embodiments. For implementation details reference may be made to the method descriptions.

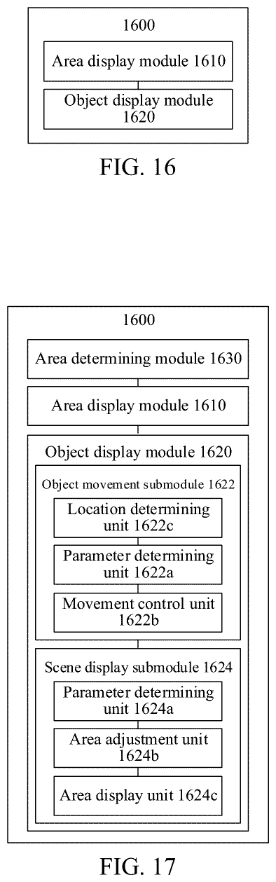

FIG. 16 is a block diagram of a virtual object display apparatus according to some embodiments. The apparatus has a function of performing the foregoing method according to some embodiments, and the function may be implemented by hardware or may be implemented by hardware executing corresponding software. The apparatus may be the terminal device described above, or may be disposed in the terminal device. As shown in FIG. 16, the apparatus 1600 may include: an area display module 1610 and an object display module 1620.

The area display module 1610 is configured to display a first area of a virtual social scene and at least one virtual object located in the first area in a user interface.

The object display module 1620 is configured to: when a first virtual object in the virtual social scene has to-be-displayed social information, if the first virtual object is located outside a second area of the virtual social scene, control the first virtual object to be displayed in the user interface and display the social information of the first virtual object. The second area is an entirety or a part of the first area.

In some embodiments, as shown in FIG. 17, the object display module 1620 includes an object movement submodule 1622.

The object movement submodule 1622 is configured to control the first virtual object to move from outside the second area to the second area displayed in the user interface.

In some embodiments, as shown in FIG. 17, the object movement submodule 1622 includes a parameter determining unit 1622a and a movement control unit 1622b.

The parameter determining unit 1622a is configured to determine a movement parameter of the first virtual object according to a first location at which the first virtual object is currently located and a second location to which the first virtual object is to move. The second location is located in the second area.

The movement control unit 1622b is configured to move, according to the movement parameter, the first virtual object from the first location to the second location.

In some embodiments, as shown in FIG. 17, the object movement submodule 1622 further includes a location determining unit 1622c.

The location determining unit 1622c is configured to determine a location point closest to the first location on a bounding box of the second area as the second location.

In some embodiments, the movement control unit 1622b is configured to: when the first virtual object meets a first condition, control the first virtual object to move from the second location back to the first location.

In some embodiments, the first virtual object is displayed in a first form when moving, the first virtual object is displayed in a second form when not moving, and the first form is different from the second form.

In some embodiments, as shown in FIG. 17, the object display module 1620 further includes a scene display submodule 1624.

The scene display submodule 1624 is configured to display a third area of the virtual social scene in the user interface, the third area including the first virtual object.

In some embodiments, as shown in FIG. 17, the scene display submodule 1624 includes a parameter determining unit 1624a, an area adjustment unit 1624b, and an area display unit 1624c.

The parameter determining unit 1624a is configured to determine an offset parameter of the first area according to a first location at which the first virtual object is currently located.

The area adjustment unit 1624b is configured to adjust a location of the first area in the virtual social scene according to the offset parameter, and determine the adjusted first area as the third area.

The area display unit 1624c is configured to display the third area in the user interface.

In some embodiments, the parameter determining unit 1624a is configured to determine a location point closest to the first location on a bounding box of the second area as a third location.

The parameter determining unit 1624a is further configured to determine the offset parameter of the first area according to the first location at which the first virtual object is currently located and the third location of the second area.

In some embodiments, the area display unit 1624c is further configured to: when the first virtual object meets a first condition, switch an area displayed in the user interface from the third area back to the first area.

In some embodiments, the first condition includes at least one of the following: duration for which the first virtual object is completely displayed in the user interface is greater than or equal to a threshold; the social information of the first virtual object has been viewed; or a related task of the first virtual object has been completed.

In some embodiments, the object display module 1620 is configured to if the first virtual object is located outside the second area of the virtual social scene and the first virtual object is located in a fourth area of the virtual social scene, perform the operation of controlling the first virtual object to be displayed in the user interface and displaying the social information of the first virtual object. The first area is a part of the fourth area.

In some embodiments, the second area is a part of the first area, and a size of an annular area located outside the bounding box of the second area and inside a bounding box of the fourth area is related to a size of an interaction range of the first virtual object; and the first virtual object and the social information of the first virtual object are displayed in the interaction range of the first virtual object.

In some embodiments, as shown in FIG. 17, the apparatus further includes an area determining module 1630.

The area determining module 1630 is configured to determine an area range of at least one of the second area or the fourth area.

In some embodiments, the area determining module 1630 is configured to determine, based on a size relationship between the first area and a master virtual object, a target interaction distance of the master virtual object.

The area determining module 1630 is further configured to determine a circular area using the target interaction distance as a radius and a location of the master virtual object as a center as the area range of the second area.

The area determining module 1630 is further configured to determine the area range of the fourth area based on the first area and the target interaction distance, a distance between a point in the fourth area and a bounding box of the first area being less than the target interaction distance.

According to some embodiments, each module may exist respectively or be combined into one or more modules. Some modules may be further split into multiple smaller function modules, thereby implementing the same operations without affecting the technical effects of some embodiments. The modules are divided based on logical functions. In actual applications, a function of one module may be realized by multiple modules, or functions of multiple units may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

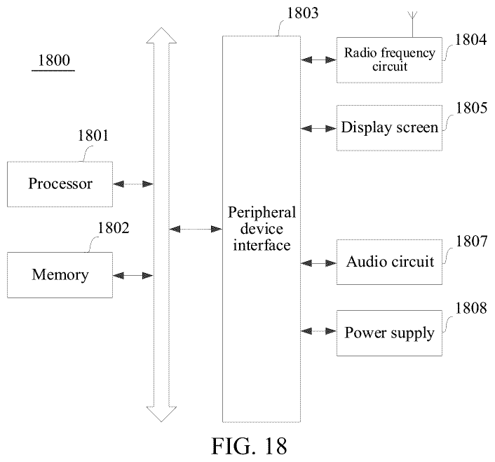

FIG. 18 is a structural block diagram of a terminal device 1800 according to some embodiments. The terminal device 1800 may be the terminal device 10 in the implementation environment shown in FIG. 1 and configured to implement the virtual object display method provided in the foregoing embodiments.

The terminal device 1800 may include: a processor 1801 and a memory 1802.

The processor 1801 may include one or more processing cores, and may be, for example, a 4-core processor or an 8-core processor. The processor 1801 may be implemented by using at least one hardware form of a digital signal processor (DSP), a field programmable gate array (FPGA), and a programmable logic array (PLA). The processor 1801 may include a main processor and a coprocessor. The main processor is configured to process data in an active state, also referred to as a central processing unit (CPU). The coprocessor is a low-power processor configured to process data in a standby state. In some embodiments, the processor 1801 may be integrated with a graphics processing unit (GPU). The GPU is configured to render and draw content that is to be displayed on a display screen. In some embodiments, the processor 1801 may further include an artificial intelligence (AI) processor. The AI processor is configured to process a computing operation related to machine learning.

The memory 1802 may include one or more computer-readable storage media. The computer-readable storage medium may be non-transient. The memory 1802 may further include a high-speed random access memory, and a non-volatile memory such as one or more magnetic disk storage devices and a flash memory device. In some embodiments, a non-transient computer-readable storage medium in the memory 1802 is configured to store at least one computer program. The computer program is configured to be executed by one or more processors to implement the virtual object display method.

In some embodiments, the terminal device 1800 may include: a peripheral device interface 1803 and at least one peripheral device. The processor 1801, the memory 1802, and the peripheral device interface 1803 may be connected through a bus or a signal cable. Each peripheral device may be connected to the peripheral device interface 1803 through a bus, a signal cable, or a circuit board. The peripheral device includes: at least one of a radio frequency circuit 1804, a display screen 1805, an audio circuit 1807, or a power supply 1808.

A person skilled in the art may understand that the structure shown in FIG. 18 constitutes no limitation to the terminal device 1800, and the terminal device 1800 may include more or fewer components than those shown in the figure, or some components may be combined, or a different component deployment may be used.

Some embodiments further provide a computer-readable storage medium, having a computer program stored therein. The computer program is executed by a processor to implement the virtual object display method.

In some embodiments, the computer-readable storage medium may include: a read-only memory (ROM), a random access memory (RAM), a solid state drive (SSD), an optical disc, or the like. The RAM may include a resistance random access memory (ReRAM) and a dynamic random access memory (DRAM).

Some embodiments further provide a computer program product, including a computer program. The computer program is stored in a computer-readable storage medium. A processor of a terminal device reads the computer program from the computer-readable storage medium, and executes the computer program, to cause the terminal device to perform the foregoing virtual object display method.

“Plurality of” means two or more. “And/or” describes an association relationship for describing associated objects and represents that three relationships may exist. For example, A and/or B may represent the following three cases: Only A exists, both A and B exist, and only B exists. The character “/” may indicate an “or” relationship between the associated objects. In addition, the operation numbers described show an example execution sequence of the operations. In some embodiments, the operations may not be performed according to the number sequence. For example, two operations with different numbers may be performed simultaneously, or two operations with different numbers may be performed according to a sequence contrary to the sequence shown in the figure. This is not limited.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A virtual object display method, performed by a terminal device, comprising:
displaying a first area of a virtual social scene and at least one virtual object located in the first area of a user interface; and
based on a first virtual object in the virtual social scene having social information to be displayed, and based on the first virtual object being located outside a second area of the virtual social scene comprising an entirety or a part of the first area, displaying the first virtual object in the user interface and displaying the social information.

2. The method according to claim 1, wherein the displaying the first virtual object comprises:
moving the first virtual object from outside the second area to the second area displayed in the user interface.

3. The method according to claim 2, wherein the moving the first virtual object comprises:
determining a movement parameter of the first virtual object according to a first location at which the first virtual object is currently located and a second location to which the first virtual object needs to move, the second location being located in the second area; and
moving, according to the movement parameter, the first virtual object from the first location to the second location.

4. The method according to claim 3, wherein before the determining the movement parameter, the method further comprises:
determining a location point closest to the first location on a bounding box of the second area as the second location.

5. The method according to claim 3, wherein after the moving the from the first location to the second location, the method further comprises:
based on the first virtual object meeting a first condition, moving the first virtual object from the second location back to the first location.

6. The method according to claim 2, wherein the first virtual object is displayed in a first form when moving,
wherein the first virtual object is displayed in a second form when not moving, and
wherein the first form is different from the second form.

7. The method according to claim 1, wherein the displaying the first virtual object comprises:
displaying a third area of the virtual social scene comprising the first virtual object.

8. The method according to claim 7, wherein the displaying the third area comprises:
determining an offset parameter of the first area according to a first location at which the first virtual object is currently located;
determining an adjusted first area as the third area based on adjusting a location of the first area according to the offset parameter; and
displaying the third area in the user interface.

9. The method according to claim 8, wherein the determining the offset parameter comprises:
determining a location point closest to the first location on a bounding box of the second area as a third location; and
determining the offset parameter of the first area according to the first location at which the first virtual object is currently located and the third location of the second area.

10. The method according to claim 7, wherein after the displaying the third area comprises:
based on the first virtual object meeting a first condition, switching an area displayed in the user interface from the third area back to the first area.

11. A virtual object display apparatus, comprising:
at least one memory configured to store computer program code; and
at least one processor configured to read the program code and operate as instructed by the program code, the program code comprising:
area display code configured to cause at least one of the at least one processor to display a first area of a virtual social scene and at least one virtual object located in the first area of a user interface; and
object display code configured to cause at least one of the at least one processor to: based on a first virtual object in the virtual social scene having social information to be displayed, and based on the first virtual object being located outside a second area of the virtual social scene comprising an entirety or a part of the first area, display the first virtual object in the user interface and display the social information.

12. The virtual object display according to claim 11, wherein the object display code is configured to cause at least one of the at least one processor to display the first virtual object by moving the first virtual object from outside the second area to the second area displayed in the user interface.

13. The virtual object display according to claim 12, wherein the moving the first virtual object comprises:
determining a movement parameter of the first virtual object according to a first location at which the first virtual object is currently located and a second location to which the first virtual object needs to move, the second location being located in the second area; and
moving, according to the movement parameter, the first virtual object from the first location to the second location.

14. The virtual object display according to claim 13, wherein before the determining the movement parameter, the object display code is configured to cause at least one of the at least one processor to determine a location point closest to the first location on a bounding box of the second area as the second location.

15. The virtual object display according to claim 13, wherein after the moving the first virtual object from the first location to the second location, the object display code is configured to cause at least one of the at least one processor to, based on the first virtual object meeting a first condition, move the first virtual object from the second location back to the first location.

16. The virtual object display according to claim 2, wherein the first virtual object is displayed in a first form when moving,
wherein the first virtual object is displayed in a second form when not moving, and
wherein the first form is different from the second form.

17. The virtual object display according to claim 11, wherein the object display code is configured to cause at least one of the at least one processor to display a third area of the virtual social scene comprising the first virtual object.

18. The virtual object display according to claim 17, wherein the object display code is configured to cause at least one of the at least one processor to display the third area by:
determining an offset parameter of the first area according to a first location at which the first virtual object is currently located;
determining an adjusted first area as the third area based on adjusting a location of the first area according to the offset parameter; and
displaying the third area in the user interface.

19. The virtual object display according to claim 18, wherein the determining the offset parameter comprises:
determining a location point closest to the first location on a bounding box of the second area as a third location; and
determining the offset parameter of the first area according to the first location at which the first virtual object is currently located and the third location of the second area.

20. A non-transitory computer-readable storage medium, storing computer code which, when executed by at least one processor, causes the at least one processor to at least:
display a first area of a virtual social scene and at least one virtual object located in the first area of a user interface; and
based on a first virtual object in the virtual social scene having social information to be displayed, and based on the first virtual object being located outside a second area of the virtual social scene comprising an entirety or a part of the first area, display the first virtual object in the user interface and display the social information.
